(19) United States
(12) Patent Application Publication
(10) Pub. No.: US 2022/0147224 A1
(43) Pub. Date: May 12, 2022

(54) METHOD OF DIVINATION READING IN AUGMENTED REALITY OR VIRTUAL REALITY AND THE SYSTEM THEREOF

(71) Applicant: ADM, LLC, Los Angeles, CA (US)

(72) Inventor: Fabrizio Alliata, Los Angeles, CA (US)

(21) Appl. No.: 17/243,469

(22) Filed: Apr. 28, 2021

Related U.S. Application Data
(60) Provisional application No. 63/111,413, filed on Nov. 9, 2020.

(51) Int. Cl. G06F 3/0481; G06F 3/0488; G06F 3/0484; G06T 13/80; G06F 3/01; G06T 13/20; G06N 20/00

(52) U.S. Cl. CPC G06F 3/04815; G06F 3/04883; G06F 3/04842; G06N 20/00; G06F 3/015; G06T 13/20; G06T 13/80

(57) ABSTRACT

The present invention relates to a method of divination reading in augmented reality (AR) or virtual reality (VR), wherein the AR or VR image displays on the screen of the device in real-time when the divination reading is executed in the device; preferably, the method allows a user to invite another user to help to in interpret divination in AR or VR interactively in real-time. The biosensors and Artificial Intelligence module may be incorporated into the divination reading. The present invention combines tarot and astrology reading, taking the user's body and mind status into account and incorporating AI technology.

This non-provisional application claims priority under 35 U.S.C.:. § 119(a) on US Provisional Patent Application No(s). 63/111,413 filed on Nov. 9, 2020, the entire contents of which are hereby incorporated by reference.

### FIELD OF THE INVENTION

The present invention relates generally to a method of divination reading in augmented reality (AR) or virtual reality (VR) and, more particularly, to a method of divination reading in AR or VR, wherein an AR or VR image and/or animation effect displays on the screen of a device when divination interpretation is executed.

### BACKGROUND OF THE INVENTION

In the art of mysticism, those divination practitioners, like fortune teller, has been trying to interpret the practice, including gaining insight into the past, present or future by using cards, natal charts, coins, or tea, sometimes following with formulating a question, towards the inquirers.

Current divination tools have incorporated the AR or VR in a smart electronic device into the divination reading in order to make the inquirers more involved in the practice. For instance, the recent AR or VR technology allows the user to scan or capture the image on the cards or papers via a display terminal, then and see the 2D or 3D animation on the screen, which interprets the fortune or fate reading in an imagery way (visualization).

One problem with the current divination visualizations in the art is that the card readings needs a physical card to be scanned or captured. For example, tarot interpreting in visualization demands a 2D illustration card printed with specification elements, like a scorpion to captured on a camera of a smart device, to then present a scorpion animation on the screen to the user.

Another limitation to current visualization technology in mystical realm is the nonactive participation of the user or inquirer. Although those electronic applications or programs realize the interpretation with the absence of a prophet, there is no formulation of questions or only generic questions instead of more individual and personal questions.

In addition, an essential flaw exists because those interpreting technologies have insufficient information including the wellness or level of spirituality or excitement, to be considered in practicing the divination. Thus, absent of the spiritual information, the results of interpretation would be not holistic or accurate.

Other disadvantages in the art of divination via smart terminal include the narrow coverage for some special or simple cards reading, for example, not covering astrology, lacking the deep interaction between users and professionals, etc. Also, some applications on device for tarot or astrology do not apply AR or VR technology to visualize the reading, process.

Therefore, what is clearly needed is a holistic divination interpretation technology in AR or VR that can solve those problems mentioned above.

### SUMMARY OF THE INVENTION

In one embodiment of the present invention, a method of divination reading in AR or VR is provided, comprising, choosing one of reading schemes by tapping or typing on the screen of a device; displaying a set of cards on the screen of the device, the cards being shuffled by a continuous touch movement on the screen; choosing some of cards by tapping the screen and placing the chosen cards apart from the remaining cards by tapping on the screen; flipping the chosen cards one by one; displaying an AR or VR image and then presenting a textual interpretation after each chosen card is flipped, wherein the AR or VR image includes the animated elements of the chosen card, and a textual interpretation includes the name and meaning of the chosen card in the divination language.

Also in one embodiment the AR or VR image displays with an animation and audio. Also in one embodiment the animation comprises a spinning and moving of the image. Also in one embodiment other users can be invited to join the card reading and interpretation via operating the device in real-time. Also in one embodiment the AR or VR image is observed via a mobile device and headset. Also in one embodiment the divination is tarot reading, Also in one embodiment the AR or VR image for tarot reading includes 3D symbolic character and number of the chosen cards.

In another aspect of the present invention a method of astrology reading in AR or VR is provided, comprising choosing one of reading schemes by tapping or typing on the screen of a device; choosing some specific conditions, including, date, time and location by tapping or inputting the screen; displaying an astrological chart on the screen; displaying an AR or VR image and then presenting a textual interpretation, wherein the AR or VR image includes the animated elements of chart, and a textual interpretation includes the name and meaning of the chart in the astrology language.

Also in one embodiment the method of astrology reading is implement by choosing a specific planet to display in AR or VR for educational purpose. Also in one embodiment other users can be invited to join the astrology reading and interpretation via operating the device in real-time. Also, in one embodiment the AR or VR image of astrology reading includes 3D planets, stars, orbits, halos, horoscope, or the combination thereof.

In another aspect of the present invention a system of interpreting divination in augmented reality (AR) or virtual reality (VR) based on collecting and mapping biometric data of a user is provided, comprising a device with a screen, photographing unit and processor, implementing the divination interpretation in AR or VR; and biosensors, collecting and sending the collected data to the device; wherein the device mapping the collected data and outputting the user's status of body and emotion on the screen of the device in real-time.

Also in one embodiment the biometric data is selected from the group of blood type, blood pressure, blood sugar, blood oxygen concentration, heart rate, body temperature, brain energy density, pulse rate, facial skin texture, skin tension and combination thereof Also in one embodiment the biosensors are selected from the group of body temperature sensor, blood type sensor, blood pressure sensor, blood oxygen sensor, pulse sensor, blood sugar sensor, heart rate sensor, skin tension sensor and combination thereof Also in one embodiment the biosensors are built in the device or connected with the device. Also in one embodiment the biosensors are connected with the device by wire or wireless. Also in one embodiment the aura reading is performed via visualization of the biometric data, wherein on the screen of the device, the aura around the user is presented.

In another aspect of the present invention a system of interpreting divination in augmented reality (AR) or virtual reality (VR) is provided, comprising a device with a screen, photographing unit and processor, implementing the interpretation in AR or VR; biosensors, collecting biometric data of the user and sending the collected data to the device; and an Artificial Intelligence module integrated in the device, processing the collected data from the biosensors based on the learning; the initial corresponding paths, wherein the artificial intelligence module is configured with instructions to:

learn the initial corresponding paths, where the initial data sets are corresponded to an initial pattern; save the learning corresponding paths for training; and create new corresponding paths based on the training when some new data sets present, where the new data sets are directed to initial patterns;
wherein the device processes the collected data via the Artificial Intelligence module and outputting the user's status of body and emotion on the screen of the device.

Also in one embodiment the Artificial Intelligence module is preset with initial patterns for body and emotion status, the initial pattern corresponding to initial sets of biometric data. Also in one embodiment another user is invited to join the interpretation and adds new learning corresponding paths into the training, wherein the invited user corresponds a new real-time data set to the initial pattern. Also in one embodiment another user is invited to join the interpretation and corrects the current learning corresponding path of the training when the new learning corresponding path created by the invited user conflicts with the current learning corresponding path.

### BRIEF DESCRIPTION OF THE DRAWINGS

The invention will now be described, by way of example, with reference to the accompanying drawings, in which:

FIG. 1 is a flowchart showing steps of tarot reading divination method according to an embodiment of the present invention.

FIG. 2 is a diagram of a brief interpretation of tarot cards according to an embodiment of the present invention.

FIG. 3 illustrates the tarot reading in AR or VR according to an embodiment of the present invention.

FIG. 4 illustrates the tarot reading based on an interaction with another user according to an embodiment of the present invention.

FIG. 5 illustrates AR image presentation in an astrology reading according to an embodiment of the present invention.

FIG. 6 illustrates a 3D image in astrology reading according to an embodiment of the present invention.

FIG. 7 illustrates a divination reading system by incorporating biosensors according to an embodiment of the present invention.

FIG. 8 is a diagram of placing thumb on screen according to an embodiment of the present invention.

FIG. 9 is a diagram of aura reading according to an embodiment of the present invention.

FIG. 10 is a block diagram of corresponding relation between initial patterns and initial data sets in a divination reading system incorporating an Artificial Intelligence module according to an embodiment of the present invention.

FIG. 11 is a block diagram of processing data by an Artificial Intelligence module in one embodiment according to an embodiment of the present invention.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.”Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure which is defined by the claims, For purposes of description herein, the terms “upper”, “lower”, “left”, “rear”, “right”, “front”, “vertical”, “horizontal”, and derivatives thereof shall relate to the invention as oriented in the drawings. Furthermore, there is no intention to be bound by any expressed or implied theory presented in the preceding technical field, background, brief summary or the following detailed description. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not o be considered as limiting, unless the claims expressly state otherwise.

At the outset, it should be clearly understood that like reference numerals are intended to identify the same structural elements, portions, or surfaces consistently throughout the several drawing figures as may be further described or explained by the entire written specification of which this detailed description is an integral part. The drawings are intended to be read together with the specification and are to be construed as a portion of the entire “written description” of this invention as required by 35 U.S.C. § 112.

“Tarot reading” means a practice of using tarot cards to gain insight into the past, present or future by choosing and interpreting cards by a fortuneteller, optionally with a formulation of some questions and answers. Particularly in the invention, the tarot reading is implemented in the device without physical card decks. Preferably, a mobile application installed in the device can practice the tarot reading. Preferably, via the device, the invention includes various tarot reading schemes, such as Card of the Day, Past Present Future, Love, Ambition, or Create Your Own etc. For divination every time, the number of chosen card(s) may be 1, 3, or 5, dependent on the chosen reading scheme, In the invention, the tarot reading includes an interpretation of the tarot cards, specified to display all the information, including text, image, animation, video or audio. For example, the said information includes the card's name, Roman numeral and meaning. In addition, all the divine language, including terms and phrase, is also included in tarot reading.

Although a method and system of tarot reading is presented, the invention could also be used in any and all kinds of divination, fortune telling, and spiritual healing. So, it is not limited to tarot reading. It should include: Astrology, Palm Reading, Aura Reading, Seance, Energy Work, Clairvoyance, Mediu ship, Telepathy.

Preferably, the users can share their tarot reading experience and results in the mobile application and/or to share social media; preferably, the users can save their tarot reading/divination records in the mobile application.

“Astrology reading” means a practice using astrological charts to gain insight into the past, present or future via investigating a specific date, time and location by a fortuneteller, optionally with a formulation of some questions and answers. Particularly in the invention, the astrology reading is implemented in the device without physical cards or tools. Preferably, a mobile application installed in the device can practice the astrology reading. Preferably, via the device, the invention includes various astrology reading schemes, such as Past, Present, Future, Love, Ambition, or fortune. For divination every time, the number of chosen card(s) may be different dependent on the chosen reading scheme. In the invention, the astrology reading includes an interpretation of the astrology charts, specified to display all the information, including text, image, animation, video or audio. For example, the said information includes the various aspects of the natal chart (12 for Zodiac Signs, 12 for Astrological Planets (includes Ceres, Chiron, etc.), 12 for Astrological Houses, 7 for Astrological Aspects, 7 for Additional Systems (nodes, sidereal vs tropical, etc.) to learn more about the user's astrological signs and astrology overall. Preferably, the said formation is displayed on the screen of a display terminal (AR) or is presented in VR visualization technology, wherein the user can see all the elements or aspects in a virtual environment via VR headset or other equipment, alternatively. In the practice of astrology reading in the invention, a user can tap on the various aspects of a natal chart to interact with a 3D recreation of the natal chart.

A “device” is a smart electronic device, such as phone, tablet, computer or other type of reading device. The device includes a screen and processor. Preferably, the device has a photographing unit, such as a camera. Preferably, the user can open the camera at a person or an object when the user is practicing divination reading for the person in front of the device. All of the operations can be executed on the screen of the device, like through tapping, double tapping, dragging and dropping, flicking, scrolling, etc. Optionally, the device is integrated or connected with biosensors. In the integrated model, it requires the users to hold their fingers on the device to collect that data to receive aura readings and give other data for divination, fortune telling and spiritual healing. In an alternatively connected model (not touchable), the users use wearables on their body to collect and send that data to the device, and the device will process the data to indicate some information for divination, fortune telling and spiritual healing. Optionally, Artificial Intelligence technology is used to help to process the information collected from the biosensors.

A “user” means an operator in the invention, who operates the device and executes the divination reading. Optionally, the user may practice divination for herself/himself or others through the invented method.

The “AR image” includes a set of images consisting of a character (person or object in a card deck) and symbolic elements in divination cards being displayed in a form of an AR image on the screen of the device. Also, the AR image include animation of 2D images, 3D objects or animations to represent all the divination symbols such as cards, planets, energy aura reading, etc. The AR image is used as a concept including a static image, dynamic image and/or moving image for all the divination. The AR image is associated with the print image on the card deck in tarot reading or with the planets or natal charts in astrology reading.

The “VR image” in the invention means a 3D image in a virtual space, which is able to be watched by a user via a VR headset. The VR image for divination reading also consists of a static image, dynamic image and/or moving image in a 3D virtual space.

The AR/VR image can be observed by headset AR/VR and mobile AR/VR. The headset AR/VR runs with computers or other game devices. The mobile VR runs on a mobile device, such as a mobile phone or tablet. The headset AR/VR or mobile AR/VR can be head-mounted display (HMD), such as Stereoscope, Cardboard, Glasses and Oculus.

An “animation” means an animation effect to a moving image.

Hereinafter, the invention of divination reading in AR or VR in real-time is described in connection with embodiments with reference to the following drawings.

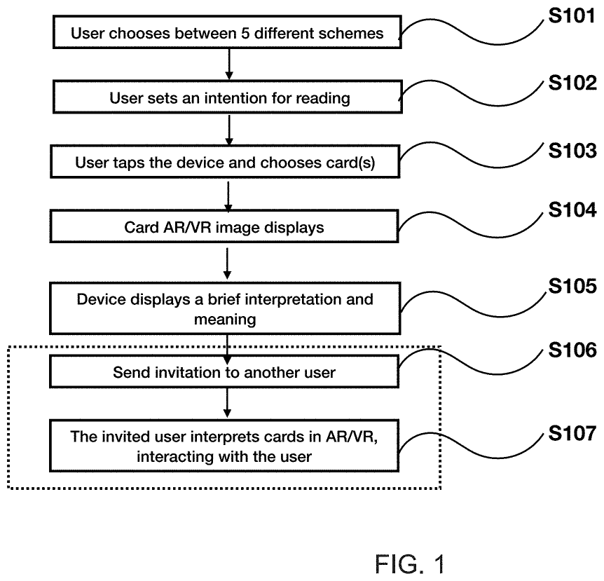

In one embodiment of the present invention presented in FIG. 1, the method of tarot reading for divination comprises: step 101, a user chooses one of the reading schemes via the device, in a way by tapping the button on the screen or typing or pronouncing the name of chosen scheme to the device; step 102, a set of cards displays on the screen, and the user shuffles to set the intention for reading; step 103, the user chooses card(s). The numbers of chosen card(s) depend on which scheme the user chose in step 101; step 104, the chosen cards flip one by one in a particular order (if multiple). Every time one card flips, the associated AR/VR image displays, and an interpretation is presented; Step 105, the device gives a brief interpretation of the flipped card, and then the user has the option to tap on different symbols to learn more meanings. Until now, a basic implementation of tarot reading has been executed.

In another aspect, the chosen card(s) is set in a particular layout (in tarot, the cards' layout is termed as “Spreads”).

Preferably, the additional step 106 and step 107 follow after Step 105 if the user would like to invite another user to interact in reading. Additionally, in Step 106, the user invites another user to interpret/read the cards. The “another” user may be a fortune teller or prophet.

In another aspect, another user can be invited through the mobile application in the device. The first user taps “Invite” on the screen to execute the “Invitation”.

In step 107, the invited user interacts with the user based on the chosen card(s).

In another aspect, the invited user interprets the cards by a text message, voice message or in app call.

In another aspect, the invited user can access the divination reading displaying image through the user's device and control the action of images in the process of interpretations. For example, the invited user can see the cards that the user has chosen, drag the target card into the center and front of the screen of the device, zoom in/out the images, and make the image move.

In another aspect, the invited user can instantly change the cards' layout or add/remove cards for divination. Preferably, the invited user can interact with the user through questions and answers to increase the interactivity and accuracy of the tarot reading.

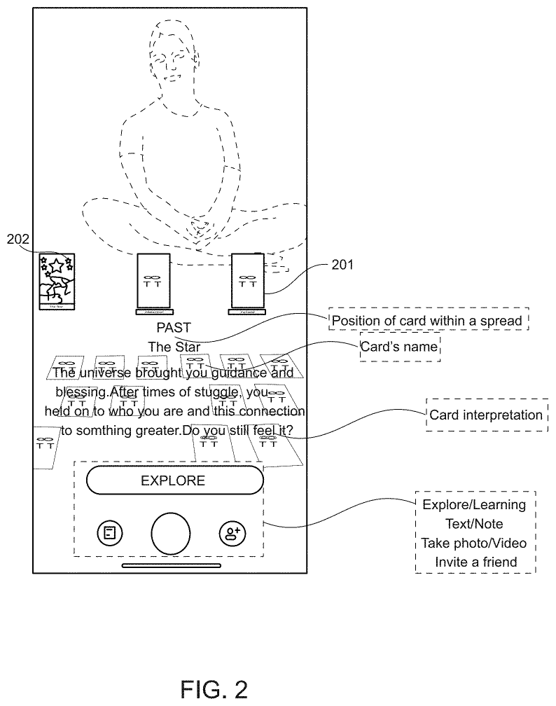

FIGS. 2-5 are illustrations for some steps of tarot reading according to one or more embodiments in the present invention.

In one embodiment of the present invention presented in FIG. 2, after the user shuffles cards, all the tarot cards are placed on the screen. The chosen cards 201 stand uprightly, apart from the remaining cards. Then, the chosen cards are flipped according to a particular order (for example, Past Present Future). After each of the chosen cards 201 is flipped, an image of the flipped card 202 and a brief text interpretation display on the screen. The user can tap different buttons on the screen to explore the tarot reading. Also, the users can choose to take a photo or make a video to save or share; the user can choose to take notes for this divination. Preferably, the user can choose to invite another user to join her/his tarot reading.

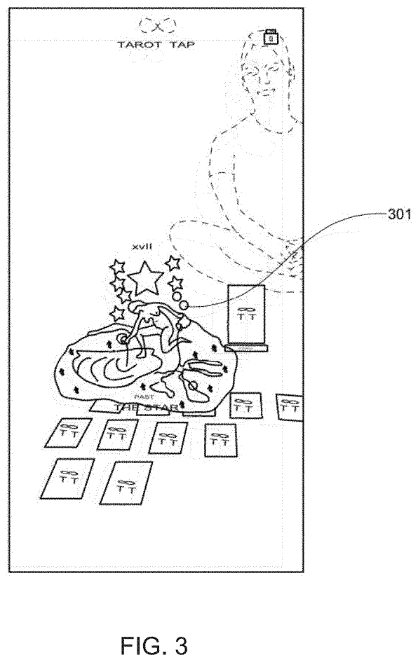

In one embodiment of the present invention presented in FIG. 3, after displaying the brief text interpretation of a flipped card, the user can explore the tarot reading in AR/VR, wherein an AR/VR image 301 associated with the flipped card is displayed. Preferably, there is a transition animation, wherein the AR/VR image 301 displays while the flipped card 202 disappears.

Preferably, another animation effect is executed. For example, the characters and/or symbolic elements in the AR/VR image 301 spin and/or shimmer. Preferably, there is an animation effect of moving the AR/VR image 301, where the AR/VR image 301 moves from standing point of the flipped card 202 to center of the screen, and preferably zooms in. Preferably, there is corresponding audio effect when the AR/VR image 301 displays and/or the animation is executed.

In another aspect, the AR/VR image is observed via an AR/VR hardware, such as AR/VR headset or mobile devices.

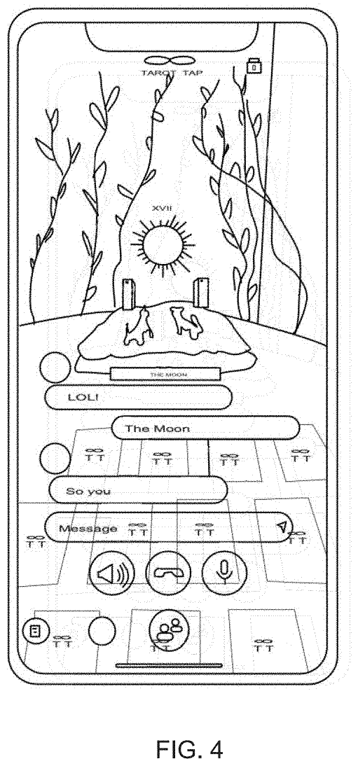

In one embodiment of the present invention presented in FIG. 4, a tarot reading method based on an interaction with another user, further comprising: the user invites another user to join the tarot reading in an interactive way.

In another aspect, the user can tap “Invite” button on the screen to send an invitation. Preferably, in the embodiment, the user and the invited user can interact with text and/or voice message.

In another aspect, the user and the invited user can interact with in-app video or audio call. Preferably, in the embodiment, the user can ask another user to help to interpret the tarot card during the interaction between the user and the invited user; At the same time, the invited user asks questions (about user's health and mood) to learn the user's situation during the divination.

In another aspect, the AR/VR image 301 and/or animation effect is displaying during the interaction between the user and the invited user.

In another aspect, the invited user can control the effect of the AR/VR image 301 and animation when he/she is interpreting the tarot cards.

In another aspect, the invited user can add cards or change the cards' layout based on the user's request or the current situation when interpreting cards.

Likewise as tarot reading illustrations, astrology reading has the similar steps essentially. In an embodiment of the present invention, when operating the astrology reading for divination, the first step is to choose some preconditions, including a specific date, time, and location. The second step is to set up the intention for reading. The third step is to display an astrological chart dating to the chosen date and time. The following steps for astrology reading is the same with the tarot reading, like AR/VR image displaying (4^{th} step), interpretation displaying (5^{th} step), and optionally inviting (6^{th} step) or interacting (7^{th} step) with other users. The only difference from tarot reading is not involved in cards or decks. The displayed images for astrology reading include Sun or Moon, Earth, Mercury, Mars, Venus, Jupiter, Saturn, Uranus, Neptune, Pluto; and their combination thereof; The layout refers to a horoscope, for example a natal chart. Basically, the positions and orbits of these planets or stars at a specified time point, for example when the user was born, will be displayed on the screen or in a virtual environment after a user performs the following steps. According to this horoscope, the device will optionally display the interpretation about the user's attitude towards money, career orientation, family relationship, orientation of lovers you like, work attitude, etc. It is notable that astrology reading also may invite a more professional to help to interpret the chart for the user.

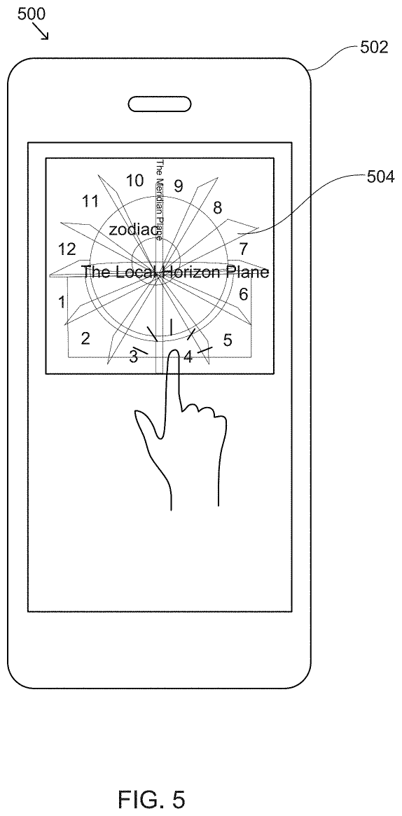

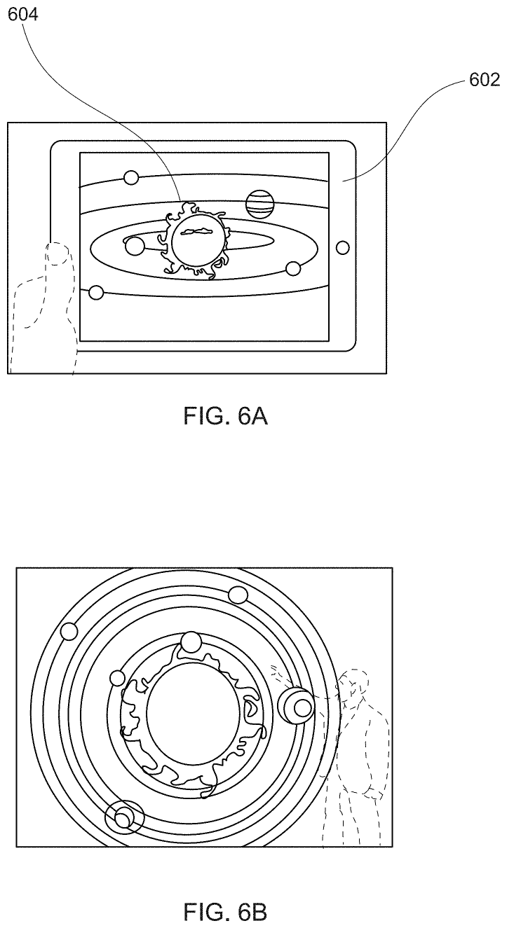

Therefore, the user can choose and alter tarot or astrology reading on the device in handy. The detailed information and presentation pattern for astrology reading are elaborated in the descriptions of following FIGS. 5-6.

FIG. 5 is a perspective view of astrology reading in AR via a smart terminal according to an embodiment of the present invention. In this example, an AR image 504 has been presented on the screen of a smart terminal 502, for astrology reading or divination.

In this example, the smart terminal may be an electronic device, such as a smart mobile phone, a monitor installed with a software or operating system, or a device specified with AR chips, preferably with a camera.

In one embodiment of the present invention, an AR image 504 for astrology presented on the screen of the smart terminal 502 may be a horoscope including a 3D natal chart, celestial map, sky-map, star-chart, cosmogram, vitasphere, radical chart, radix, chart wheel. In the example, a 3D natal chart is presented, preferably.

In the example, the 3D natal chart includes multiple astrological signs or elements, such as 12 for Zodiac Signs, 12 for Astrological Planets (includes Ceres, Chiron, etc.), 12 for Astrological Houses, 7 for Astrological Aspects, and 7 for Additional Systems (nodes, sidereal vs tropical, etc.).

Preferably, the user can rotate the 3D natal chart on the screen by rotating two fingers or zoom in a targeted position by flicking finger.

In the example, the user can tap the different positions in the natal chart to learn the astrological signs or astrology overall. After tapping one position (an aspect in the natal chart), an AR image showing detailed element in the aspect is displayed on the screen.

Although in the example the steps for astrology reading are not described, the steps or arrangements are known to the inventor. For example, the drawing of astrology charts or patterns specified with natal chart can trigger the stage view 500 as shown in FIG. 5.

FIG. 6 is perspective view of 3D planetary system presentation in astrology according to an embodiment of the present invention.

In the example, the user is able to place the planetary system 604 in a 3D virtual environment as a table top size model allowing the user to have a perspective view on the screen 602. Alternatively, the model can be enlarged and visualized via VR headset so that the 3D planetary system is viewed to surround the user. In that situation, the AR or VR image can be presented more vividly and visually, and increase the interaction and amusement of participants in the divination.

In the example, the 3D natal chart would animate in real-time reflecting e actual planetary system movement and positioning using real-time data.

In the example, the 3D natal chart would also reflect the planetary system of a specific time and date that the user wishes to do an astrological reading for. For example, the user can choose the 3D natal chart at his or her birthday time.

In the example, the steps of the astrology reading are essentially the same or followed the same pattern with the tarot reading in the above embodiment. The astrology reading displays the specified and individual AR or VR images on the screen or in a virtual environment, sharing the same presentation or visualization pattern with tarot reading.

The described methods for displaying AR or VR image in those embodiments shown in FIG. 5 and FIG. 6 are not a limiting factor in practice of the present invention. Further, the methods can be applied to the educational purpose. Specifically, the present invention also can provide a method for displaying planets or stars in AR or VR, the method comprising: choosing one of reading schemes by tapping or typing on the screen of a device; choosing some of planets by tapping the screen to explore; displaying an AR or VR image and then presenting a textual interpretation after each chosen planet is zoomed in, wherein the AR or VR image includes the planets, stars, orbits, halos, or the combination thereof. In the educational example, the AR or VR images may contain animation and audio, facilitating the education for kids.

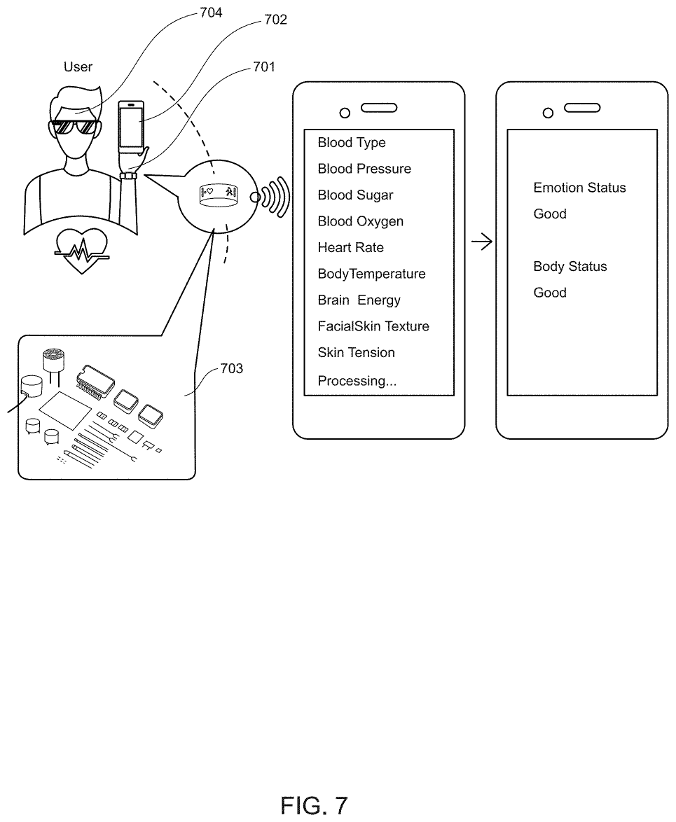

In one embodiment of the present invention presented in FIG. 7, a reading system in AR or VR incorporating biosensors is provided according to an embodiment of the present invention. The system collects and processes biometric data from the biosensors.

In the example, particularly, the system of interpreting divination in AR or VR based on collecting and mapping biometric data of a user, comprises a device with a screen, photographing unit and processor, which implements the AR or VR visualizations; and biosensors, which collects and sends the collected data to the device, wherein the device corresponds (maps) the collected data to some patterns (developing a correspond relationship) and outputs the body and emotion status on the screen of the device in real-time.

In the example, the reading process is implemented in a combination with biosensor(s), wherein a factor for physical and psychological status of the user is taken into account in the divination interpretation. For divination, a person's physical and psychological status (for example, level of physical health, mood, spirit, level of excitement etc.) influence the result of the divination, for example fortune telling. Therefore, the interactivity and meticulosity of divination can be enhanced if the reading considers the user's body and emotion status in real-time. In the example, the user's body and emotion status are evaluated on the basis of the collected biometric data via the biosensors.

In an aspect, biosensors are built in the device. It requires the users to hold their fingers on their device's screen or touch their palms with the device to collect the data (for example, hand temperature, skin tension etc.) to receive aura readings and to give other information (the level of excitement, the brain energy density, mood status, etc.) for divination, fortune telling and spiritual healing. The device is selected from smart mobile phone, tablets installed with operating system, or any electronic device on which software can be run.

Alternatively, in another aspect, the biosensors are built in a wearables that is connected with the device. Preferably, the wearables is connected with the device via wire or wireless including Bluetooth. Preferably, the wearables is selected from the group consisting of wristband, head-mounted displays, smart necklace, smartwatch, smart ring and combinations thereof. Preferably, the collected biometric data comprises blood type, blood pressure, blood sugar, blood oxygen concentration, heart rate, body temperature, brain energy, pulse rate etc. Preferably, the biosensors are selected from the group of body temperature sensor, blood type sensor, blood pressure sensor, blood oxygen sensor, pulse sensor, blood sugar sensor, heart rate sensor and combination thereof. Preferably, those biometric data collected by the biosensors is sent to the device and corresponded (mapped) into a particular body and emotion status.

Preferably, the data received by the device is corresponded, preferably via the mobile application. Thus, after data is corresponded, physical and phycology status of the user is displayed on the screen. Preferably, following step 105 (card flips and AR or VR image displays) of the method in FIG. 1, the user's body and emotion status displays on the screen, all of which are taken into account in a divination interpretation.

In an embodiment of the present invention as perhaps preferably shown in FIG. 7, the drawing illustrates a divination reading system incorporating biosensors, where a smart wristband 701 is connected to a smart phone 702. The biosensors include the temperature sensor, blood type sensor, blood pressure sensor, blood oxygen sensor, blood sugar sensor, heart rate sensor and other sensors.

In the instant embodiment, preferably, a facial recognition sensor is built in front of the smart phone, enabling the sensor to monitor the facial expression of the user and to recognize human emotions from the expressions on their face.

Together, all the biometric data for the embodiment includes blood type, blood pressure, blood sugar, blood oxygen concentration, heart rate, body temperature, brain energy, facial skin texture, skin tension, etc.

For the process implemented in the system, a divination reading is executed as the flowchart for a tarot reading example in FIG. 1. Before beginning divination reading in the phone 702, the user wears the wristband 701 in a comfortable position and makes sure the wristband 701 is connected with the phone 702 successfully, Following the process steps in FIG. 1, the user types to choose the reading scheme of “Card of the Day” in step 1. In step 2, the user shuffles cards. In step 3, the user chooses one of card decks. In step 4, the chosen card deck flips, hover for a few seconds, and then AR image displays. For instance, the ‘Moon’ card flips. Then, the associated AR image displays with animation that includes a night scene, with the moon shining, two large pillars, and a wolf and a dog howling at the moon while a crayfish emerges from the water. When animation effect is being executed, there is an audio effect including a howl or a growl. Preferably, the AR image is moved into the center of the screen and zoomed in. Following the AR image, the body and emotion status of the user displays on the screen when the user sends a request for incorporating the biometric data. Preferably, on the screen, a textual context displays: “Emotion: Good; Body: Good”. Alternatively, body and emotion status of the user can display in a graphical form, such as Emoji images. In a modified step 5, the device/application gives an interpretation with an incorporation of the user's status of body and emotion. Unlike with original step 5 in the previous embodiment without the incorporation of the instant physical and physiological status of the user, the system incorporates the emotion and health status of the user, increasing the amusement and strictness for a divination reading. More than the above process being implemented for tarot reading example following the flow in FIG. 1, a similar process may be executed in another example for energy or aura reading, details described below.

Preferably, the user wearing a VR headset 704 can observe a 3D virtual image in real-time when the divination reading is executed.

In some embodiments including an invitation to another user, after AR/VR image and divination interpretation are displayed, additionally the user asks another user to join the divination reading. The invited user is able to access the user's body and mood data information, which is incorporated into the divination interpretation, for example fortune-telling, by the invited user. Also, the invited user instantly asks the user some particular or individual questions to know the user's under-way situation. Thus, taking all the status of emotion and body into account, the invited user gives the user a complete and comprehensive interpretation of the divination.

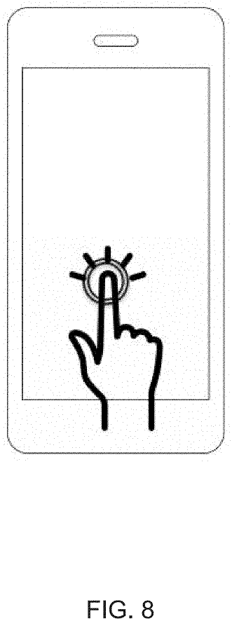

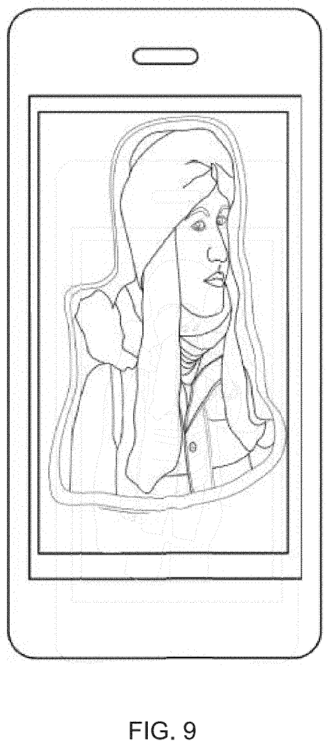

FIG. 8 is a diagram of placing thumb on screen according to an embodiment of the present invention. In this example, a user can collect his/her body information, including pulse rate, body temperature, etc., via holding the thumb on the screen of the device with build-in biosensors, without wearing any wrist or other equipment. In this example, an aura reading can be performed via placing a finger on the screen or wearing a smart wirst. The user's data is automatically presented in AR image and the user can tap on different element of the AR images to learn more about what that data represents. Alternatively, 3D animation happens around the user representing the data. Details will be described below in FIG. 9.

FIG. 9 is a diagram of aura reading according to an embodiment of the present invention. In this example, the users use mobile device with biosensors to receive data on the various types of energy they are emitting to present the aura reading.

When in operation of aura reading, essentially as mentioned before in the previous embodiments, the biosensors have collected the body and mood data information of the users, reflecting the excitement level or mental energy level of the users. For example, the high mental energy corresponds to the “good” status in emotion reflected by the data. In this situation, we will see the visualization of the users' “aura”, preferably surrounding their body, in augmented reality when the users face the camera that would animate changing frequency of movement, color and size depending on what the biosensors are picking up in real time. The color of aura would be red/blue if the user has a high/low energy or spirit; and the thickness of aura would large/small if the energy or spirit is strong/weak. Preferably, some data analytics would literally/graphically appear on the corner of the user's screen reflecting the graphs moving in real-time. Preferably, the user can tap the elements on the screen to learn more details.

In this example, preferably, the user may face the front camera in holding the device by themselves, and the data and aura can be presented automatically on the screen after the device mapped the data collected from the biosensors into the spirit status.

In this example, users may implement the aura reading to only evaluate the mood or spirit. Alternatively, the users may incorporate the aura reading into the following the divination reading described in FIG. 1-6.

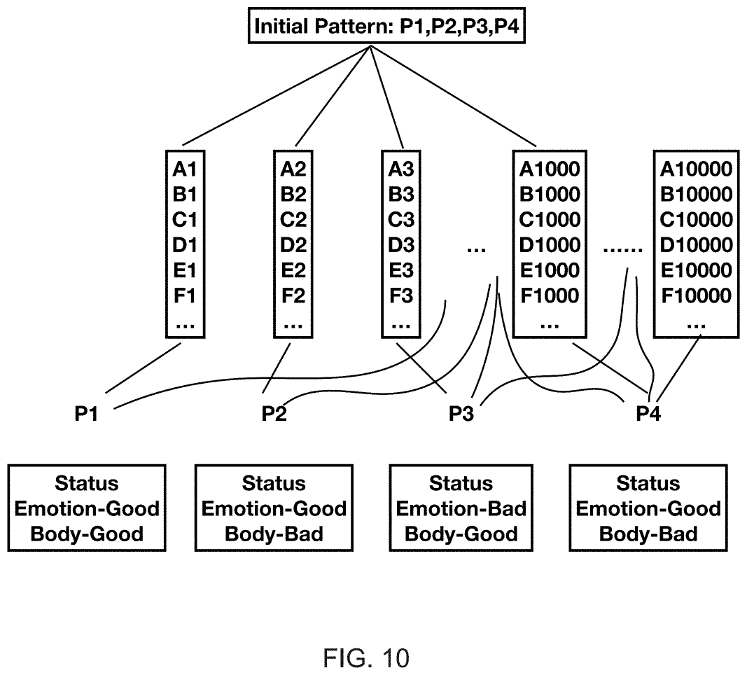

In one embodiment of the present invention, a block diagram of the corresponding relationship between initial patterns and initial data sets in a divination reading system incorporating Artificial Intelligence module presents in FIG. 10.

In a preferred embodiment, the divination reading system comprises: a device with a screen, a photographing unit and a processor, implementing interpretation in AR or VR; incorporated biosensors, collecting biometric data of the user and sending the collected data to the device, wherein the device processes the collected data and outputs the user's status of body and emotion on the screen of the device; and an Artificial intelligence module integrated in the device, executing the data processing in the device.

In another aspect, the Artificial Intelligence module is preset with initial sets of biometric data and corresponded to initial patterns for body and emotion status.

In the preferred embodiment, the evaluation for the body and emotion status of the users is more accurate and complete with an assistance of Artificial Intelligence. Based on multiple types of biosensors, various and massive data are collected and sent to the device to process. A set of data consists of different number ranges for each type of biometric data. Preferably, each initial pattern includes both a single body and emotion status, either Good or Bad, comparatively. In sum, there are four initial patterns. 10000 initial sets of sample data are inputted in the device and each of 10000 sets refers to one of four initial patterns. Each set of sample data consists of a collection of different type of biometric data. For example, a set of data is a collection/group of a numerical value ranges of body temperature (A), a numerical value range of blood pressure (B), a numerical value range of heart rate (C), a numerical value range of blood sugar (D), a numerical value range of blood oxygen (F), a numerical value range of pulse rate (F), and/or numerical value range(s) of other types of biological data, dependent on the category of biosensors. Therefore, a data set is mapped/corresponded to an initial pattern, which refers to a status of emotion and body for the user.

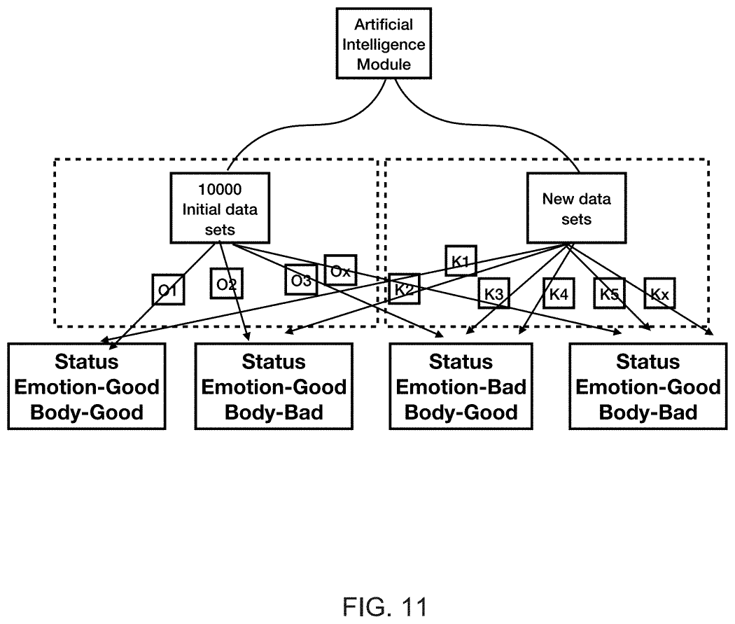

In one embodiment of the present invention, a block diagram of processing by an Artificial intelligence module is presented in FIG. 11.

In the system, AI module processes the collected data from the biosensors based on the machine learning/training of initial data sets, where the Artificial Intelligence module is configured with the following instructions: learn the initial corresponding paths (O1, O2, O3, . . . , O10000), wherein the initial data sets are corresponded/mapped to an initial pattern (P1, P2, P3, or P4); save the learning corresponding paths (O1, O2, O3 . . . , O10000) for training; and create new corresponding paths (K1, K2, . . . , Kx) based on the training when some new data sets are presented, where the new corresponding paths direct new data sets to an initial pattern (a new corresponding process).

Here, the new data set does not exist in the 10000 initial data sets ever.

Preferably, in the system incorporating AI, the invited user (human beings) adds new learning corresponding paths (N1,N2, . . . , Nx) by directing a new real-time set of data to an initial pattern or correcting/replacing the current learning corresponding paths of the training when the new learning corresponding paths (N1,N2, . . . , Nx) created by the invited user conflicts with current learning corresponding paths (O1,O2,O3 . . . ,O10000) by directing a new real-time set data to an initial pattern.

In a preferred embodiment, the Artificial Intelligence module is designed to train the device to process the collecting data from those biosensors based on the training of 10000 initial data sets so that the device learns to categorize/correspond a new set of data into the initial patterns. The Artificial intelligence module is integrated in the device and pre-set with initial patterns for body and emotion status corresponding to initial biometric data that enables the device to process the collected data from the biosensors based on the model of initial sets of data.

Although the present invention has been illustrated and described herein with reference to preferred embodiments and specific examples thereof, it will be readily apparent to those of ordinary skill in the art that other embodiment and examples may perform similar functions and/or achieve like results. All such equivalent embodiments and examples are within the spirit and scope of the present invention, are contemplated thereby, and are intended to be covered by the following claims.

What I claim is:

1. A method of divination reading in augmented reality (AR) or virtual reality (VR), comprising:
choosing one of reading schemes by tapping or typing on the screen of a device;
displaying a set of cards on the screen of the device, the cards being shuffled by a continuous touch movement on the screen;
choosing some of cards by tapping the screen and placing the chosen cards apart from the remaining cards by tapping on the screen;
flipping the chosen cards one by one;
displaying an AR or VR image and then presenting a textual interpretation after each chosen card is flipped, wherein the AR or VR image includes the animated elements of the chosen card, and a textual interpretation includes the name and meaning of the chosen card in the divination language.

2. The method of claim 1, wherein the AR or VR image displays with an animation and audio.

3. The method of claim 3, wherein the animation comprises a spinning and moving of the image.

4. The method of claim 1, wherein other users can be invited to join the card reading and interpretation via operating the device in real-time.

5. The method of claim 1, wherein the AR or VR image is observed via a mobile device and headset.

6. The method of claim 1, wherein the divination is tarot reading, and the AR or VR image for tarot reading includes 3D symbolic character and number.

7. A method of astrology reading in augmented reality (AR) or virtual reality (VR), comprising:
choosing one of reading schemes by tapping or typing on the screen of a device;
choosing some specific conditions, including date, time and location by tapping or inputting the screen;
displaying an astrological chart on the screen; and
displaying an AR or VR image and then presenting a textual interpretation, wherein the AR or VR image includes the animated elements of chart, and a textual interpretation includes the name and meaning of the chart in the astrology language.

8. The method of claim 7, wherein other users can be invited to join the astrology reading and interpretation via operating the device in real-time.

9. The method of claim 7, wherein the AR or VR image of astrology reading includes 3D planets, stars, orbits, halos, or the combination thereof.

10. The method of claim 9, wherein The AR or VR image for displaying planets, stars, or orbits is applied for educational purpose.

11. A system of interpreting divination in augmented reality (AR) or virtual reality (VR) based on collecting and mapping biometric data of a user, the system comprising:
a device with a screen, photographing unit and processor, implementing divination interpretation in AR or VR; and
biosensors, collecting biometric data of a user and sending the collected data to the device;
wherein the device mapping the collected data and outputting the user's status of body and emotion on the screen of the device in real-time.

12. The system of claim 11, wherein the biometric data is selected from the group of blood type, blood pressure, blood sugar, blood oxygen concentration, heart rate, body temperature, brain energy density, pulse rate, facial skin texture, skin tension and combination thereof.

13. The system of claim 11, wherein the biosensors are selected from the group of body temperature sensor, blood type sensor, blood pressure sensor, blood oxygen sensor, pulse sensor, blood sugar sensor, heart rate sensor, skin tension sensor and combination thereof.

14. The system of claim 11, wherein the biosensors are built in the device.

15. The system of claim 11, wherein the biosensors are connected with the device by wire or wireless.

16. The system of claim 11, wherein aura reading is implemented via the visualization of the biometric data collected from the biosensors, and the interpretation in AR or VR is presented on the screen of the device.

17. The system of claim 11, wherein further an Artificial Intelligence module integrated in the device, processing the collected data from the biosensors based on the learning the initial corresponding paths, and the artificial intelligence module is configured with instructions to:
learn the initial corresponding paths, where the initial data sets are corresponded to an initial pattern;
save the learning corresponding paths for training; and
create new corresponding paths based on the training when some new data sets present, where the new data sets are directed to initial patterns;
wherein the device processes the collected data via the Artificial Intelligence module and outputting the user's status of body and emotion on the screen of the device.

18. The system of claim 17, wherein the Artificial Intelligence module is preset with initial patterns for body and emotion status, the initial pattern corresponding to initial sets of biometric data.

19. The system of claim 17, wherein another user is invited to join the divination reading and adds new learning corresponding paths into the training, wherein the invited user corresponds a new real-time data set to the initial pattern.

20. The system of claim 17, wherein another user is invited to join the divination reading and corrects the current learning corresponding path of the training when the new learning corresponding path created by the invited user conflicts with the current learning corresponding path.
